(19) United States
(12) Patent Application Publication
(10) Pub. No.: US 2013/0071715 A1
(43) Pub. Date: Mar. 21, 2013

(54) Electricalchemical device

(71) Applicants: Yen Wei Hsu, Taipei (TW); Whei-Chyou Wu, Fremont, CA (US)

(72) Inventors: Yen Wei Hsu, Taipei (TW); Whei-Chyou Wu, Fremont, CA (US)

(21) Appl. No.: 13/235,355

(22) Filed: Sep. 17, 2011

(51) Int. Cl. H01M 8/20

(52) U.S. Cl. 429/105

(57) ABSTRACT

By providing external energy interacts with an electrolyte solution of an electricalchemical device to change the activation energy at the electrodes to control the rate of chemical reactions.

### BACKGROUND OF INVENTION

1. Field of the Invention

This invention relates to an electricalchemical device, more particularly, an electrokinetics process to control an electricalchemical device.

2. Description of Related Art

For any RLC circuit can be expressed by two known first-order differential equations as followed:

$$\{ \begin{matrix}\frac{d x}{d t} = y - F ( x ) \\ \frac{d y}{d t} = - g ( x )\end{matrix} \qquad ( 1 )$$

of which x and y are state variables of which any one is current and the other one is voltage and F(x) is the impedance function. The two first-order differential equations can be expressed by a second-order differential equation as shown by:

$$\frac{{d}^{2} x}{d {t}^{2}} + \frac{d F ( x )}{d x} \frac{d x}{d t} + g ( x ) = 0$$

$$or$$

$$\frac{{d}^{2} x}{d {t}^{2}} + f ( x ) \frac{d x}{d t} + g ( x ) = 0$$

where

$$f ( x ) = \frac{d F ( x )}{d x} .$$

Please note that the

$$\frac{d F ( x )}{d x} in \frac{d x}{d t}$$

term. According to Liénard Stabilized Systems, for any stablized periodical system,

$$\frac{d F ( x )}{d x} > 0 and \frac{d F ( x )}{d x} < 0$$

hold simultaneously and the two must pass

$$\frac{d F ( x )}{d x} = 0 ,$$

where

$$\frac{d F ( x )}{d x} >$$

is defined as positive differential resistance or PDR in

$$\frac{d F ( x )}{d x} < 0$$

is defined as negative differential resistance or NDR in short, and

$$\frac{d F ( x )}{d x} = 0$$

is a constant resistance or defined as pure resistance. Please note again that variable x can be current or voltage. The short discussion above is helpful to easier understand the definitions of the PDR and the NDR appearing in the present invention.

This section talked about the relation between activation energy and chemical reaction rate.

Referred to [8, Chapter 4], [19, Chapter 9], [5, Chapter 3], [4], [3, Chapter 7 and 14], [16, Chapter 2,3,5], in short, the Arrhenius equation (Arrhenius, 1889) gives “the dependence of the rate constant k of chemical reactions on the temperature T (in absolute temperature, such as Kelvins) and activation energy Eₐ”, as shown

$$k = A {e}^{- ( \frac{{E}_{a}}{RT} )} \qquad ( 2 )$$

where A is the pre-exponential factor or simply the prefactor and R is the ideal gas constant. The units of the pre-exponential factor are identical to those of the rate constant and will vary depending on the order of the reaction. If the reaction is first order it has the units s⁻¹, and for that reason it is often called the frequency factor or attempt frequency of the reaction. Most simply, k is the number of collisions that result in a reaction per second, A is the total number of collisions (leading to a reaction or not) per second and e^{-E}^{ₐ}^{/RT} is the probability that any given collision will result in a reaction. When the activation energy is given in molecular units instead of molar units, e.g., joules per molecule instead of joules per mole, the Boltzmann constant is used instead of the gas constant. It can be seen that either increasing the temperature or decreasing the activation energy (for example through the use of catalysts) will result in an increase in rate of reaction.

Given the small temperature range kinetic studies occur in, it is reasonable to approximate the activation energy as being independent of the temperature. Similarly, under a wide range of practical conditions, the weak temperature dependence of the pre-exponential factor A is negligible compared to the temperature dependence of the exp(−Eₐ/RT) factor; except in the case of “barri-erless” diffusion-limited reactions, in which case the pre-exponential factor is dominant and is directly observable.

Referred to [24, Page 6.], (2) can be in terms of Gibbs free energy as the form of

$$k = A {e}^{- ( \frac{Δ G}{RT} )} \\ and \\ A = γ {λ}^{2} Γ \qquad ( 3 )$$

where γ, λ and Γ are the number of neighbor jump sites, jump distance and jump frequency respectively. The Arrhenius pre-exponential factor A in (3) depends on the frequency of vibration of the atoms at the reaction interface and therefore is affected by microwave irradiations.

The following talked about interfacial interaction of charged particles between two different phases. Referred to [7], [22], the interfacial interaction of electrons between two different phases. Referred to [6, Chapter 5,6,9,13], [12], [3, Chapter 1,4,31], [16, Chapter 2,3,5], the electrolyte solution is modeled by the Brownian motion. Let the current density j (unit A/m²) in an electric field to be the following form, [21, Chapter 1], [27, Page 199],

j=σE (4)

where σ (unit (Ωm)⁻¹) and E (unit Volt/m) are the conductivity and applied electric field respectively.

The following discusses about an external applied electrical field E acting on an electrolyte solution and the charged particles interaction motion in the electrolyte solution. Two species (i=1 and 2) salt AₘBₙ, dissociated completely into ions A and B of charge z₁ and z₂ as shown by

AₘBₙ→mA+nB

where m and n are the stoichiometric number. With the initial electrically neutral

mz₁+nz₂=0

and concentration balanced conditions

z₁c₁⁰+z₂c₂⁰=0

its equation of motion is

$${m}_{i} \frac{d {V}_{i}}{d t} = - {ζ}_{i} {V}_{i} + F ( t ) + {z}_{i} E \qquad ( 5 )$$

where mᵢ, ζᵢ, zᵢ and F(t) are the mass of each ion, friction constant(for large spherical ions, aᵢζᵢ=6πηaᵢ, η is viscosity coefficient of solution), the charge number of ions and the random force with zero mean-value respectively. Since no chemical reaction in this solution, the number of ions conserved, i.e.

$$\frac{\partial {c}_{i} ( r , t )}{\partial t} + ∇ \cdot {J}_{i} ( r , t ) = 0 \qquad ( 6 )$$

where cᵢ (r, t), Jᵢ (r,t), r, are the ion flux of type i, ions concentration and the position vector of ions respectively. Furthermore, the flux can be divided into two parts as

Jᵢ(r,t)=−Dᵢ∇cᵢ(r,t)cᵢ(r,t)Vᵢ(r,t)

where using the Fick law, k_{B} is Boltzmann constant, the hydrodynamic diffusion coefficient Dᵢ is

$$\begin{matrix}{D}_{i} = \frac{{k}_{B} T}{{ζ}_{i}} \\ = \frac{{k}_{B} T}{6 πη {a}_{i}} ( 8 )\end{matrix} \qquad ( 7 )$$

In other words, for a larger viscosity obtains larger frictional force f_{fr}

$$\begin{matrix}{f}_{fr} = {ζ}_{i} {V}_{i} \\ = - 6 π η {a}_{i} {V}_{i}\end{matrix}$$

resulting in the lower diffusion of this charged particle. Taking the average operation for the equation (5), the solution of (5) is

$${V}_{i} ( r , t ) = {V}_{i}^{0} {e}^{- \frac{{ζ}_{i} t}{{m}_{i}}} + \frac{{z}_{i} E}{{ζ}_{i}} ( 1 - {e}^{- \frac{{ζ}_{i} t}{{m}_{i}}} )$$

where the term

$${e}^{- \frac{{ζ}_{i} t}{{m}_{i}}}$$

decays very quickly, i.e.,

$${e}^{- \frac{{ζ}_{i} t}{{m}_{i}}}$$

becomes zero after a time period, t≧t₀, and the most domonant term in the above equation describing the migration of the charged particles is the term containing the external applied electric field E as shown by

$$\begin{matrix}{V}_{i} ( r , t ) = \frac{{z}_{i} E ( r , t )}{{ζ}_{i}} \\ = ( \frac{{D}_{i} {z}_{i}}{{k}_{B} T} ) E ( r , t ) \\ = β {D}_{i} {z}_{i} E ( r , t )\end{matrix} \qquad ( 9 )$$

Let the Doppler (frequency) shift ωᵢ(q) be the coefficient of (9) as

wᵢ(q)=βDᵢzᵢ (10)

where q is the spatial Fourier transform vector.

$$σ = \frac{j {z}_{i}}{{V}_{i} ( r , t ) ζ}$$

That is, the migration of charged particles is in wave-like forms. The strength of this external applied electric field is a driven force (Coulomb force)

$$\begin{matrix}{f}_{drv} = QE \\ = {z}_{i} FE\end{matrix}$$

where Q is the charge (unit C), each type of ion carrying charge zᵢF (per mole) which Avogadro constant N_{A}=6.022×10²³/mol and elemetary charge Q⁰=1.62×10⁻¹⁹C, the Faraday constant F has obtained as the

$$\begin{matrix}F = {N}_{A} {Q}^{0} \\ = 96485 C . \text{/} mol\end{matrix}$$

for driving the migration of ions and its polarity is the direction of driving forces (repulsive or attractive).

According to the analysis above, the electrical field was introduced but nothing talked about current. Current can only be observed in a closed loop so that the electrical field E has to be implemented by an open circuit. The following discussed some important properties of electrodes such as polarization and reaction rate.

The Tafel equation, [5, Chapter 6], [8, Chapter 4], relates the rate of an electrochemical reaction to the shift of potential or overpotential, ΔE, and was first deduced experimentally and was later shown to have a theoretical justification. Consider the simple redox reactions of type

Red⇄Ox+ne⁻ (11)

where n is the stoichiometric number, Red stands for reduction in short, and Ox stands for oxidation in short. On a single electrode the Tafel equation can be stated as

$$Δ E = a + b ln ( \frac{j}{{j}_{0}} ) \qquad ( 12 )$$

where ΔE is the overpotential, (unit Volt),

$$a = - \frac{RT}{α F} ln {j}_{0}$$

is the constant, b is the so called “Tafel slope”, j and j₀ are the so called “exchange current density”, (unit A/m²). Also it can be charactered by the Nernst equation

$$\begin{matrix}Δ E = \frac{RT}{n F} ln \frac{{C}_{Ox}}{{C}_{red}} & ( 13 ) \\ E = {E}_{0} + \frac{RT}{n F} ln \frac{{C}_{Ox}}{{C}_{ref}} & ( 14 )\end{matrix}$$

where c_{red}, c_{Ox} are bulk concentrations of the anode and cathode electrodes respectively. Another form of Tafel slope b is

$$b = \frac{RT}{α F} \qquad ( 15 )$$

where α is a dimensionless coefficient (from 0 to 1) which called energy transfer coefficient and defined as the follow forms

$$\begin{matrix}α = \frac{RT}{F} \vert \frac{\partial ln k}{\partial E} \vert \\ = \frac{\partial {E}_{a}}{\partial E}\end{matrix}$$

Also the Tafel equation (12) can be in an exponential form of

$$j = nFk exp ( \pm \frac{α F Δ E}{RT} ) \qquad ( 16 )$$

where k is the same meaning as the (2) or (3) equal to

$$k = \frac{1}{n F} exp ( \frac{- α F Δ E}{RT} ) / a$$

The exchange current in terms of polarization or overpotential can be obtained from (16)

$$\begin{matrix}i = jA \\ = n AFk exp ( \pm \frac{α F Δ E}{RT} )\end{matrix} \qquad ( 17 )$$

where A is an effective area of electrodes. The general kinetic equation is valid for the net exchange current between cathode and anode electrodes like as

$$\begin{matrix}i = {i}_{a} - {i}_{c} \\ = n {AFk}_{red} {C}_{ref} {e}^{( \frac{α F Δ E}{RT} )} - n {AFk}_{Ox} {C}_{Ox} {e}^{( - \frac{β F Δ E}{RT} )} \\ = {j}_{0} A ( {e}^{( \frac{α F Δ E}{RT} )} - {e}^{( - \frac{β F Δ E}{RT} )} )\end{matrix} \qquad \begin{matrix}\begin{matrix} \\ ( 18 )\end{matrix} \\ \begin{matrix} \\ ( 19 )\end{matrix}\end{matrix}$$

where (17) and (18) are called the polarization equations, (19) is called Volmer-Butler equation, k_{red}, k_{Ox} are reaction rate constants respectively of the anode electrode and cathode electrode and at equilibrium potential E₀,

$$\begin{matrix}{j}_{0} = {nFk}_{red} {C}_{ref} {e}^{( \frac{α F {E}_{0}}{RT} )} \\ = {nFk}_{Ox} {C}_{Ox} {e}^{( - \frac{β {FE}_{0}}{RT} )}\end{matrix}$$

or in Nernst form (14),

$$E = {E}_{0} + \frac{RT}{( α + β ) F} ( ln \frac{{k}_{Ox}}{{k}_{ref}} + ln \frac{{C}_{Ox}}{{C}_{red}} )$$

comparing to the Nernst equation (13), such that

α+β=n

for one-electron reaction, referred to (11), n=1, i.e.,

α+β=1

the values of energy transfer coefficients are usually assumed as α=β=0.5 and

$$\frac{{k}_{Ox}}{{k}_{red}} = exp ( \frac{{FE}_{0}}{RT} )$$

i.e., coefficients of oxidation and reduction reactions as k_{Ox}, k_{red}, c_{Ox}, and C_{red} are always correlated. In (18), the net exchange current are firmly related to many factors like as the electrodes area A, chemical reaction rate constants as k_{red} (at reduction), k_{Ox} (at oxidation), bulk concentrations c_{red} (at reduction), c_{Ox} (at oxidation), and electrodes polarization or overpotential ΔE respectively. Furthermore, the chemical reaction rate is proportional to the total exchange currents on the electrodes as well as the polarizations on the electrodes of which polarizations occurred at the same time.

A polarization of an electrode is defined by a shift of potential away from an equilibrium value of the electrode. A higher polarization (a higher potential shift) on an electrode,

$$Δ E > \frac{RT}{F} ,$$

expresses a lower conductivity of electrodes which is hard to discharge spontaneously, that is the slower reaction rate of electrodes obtained. For a lower polarization (a lower potential shift),

$$Δ E < \frac{RT}{F} ,$$

expresses a higher conductivity of electrodes and a fast reaction rate of electrodes is obtained. This is a highly definite reason why an external electric field has to be applied to electrolyte solution not to electrodes.

In (18), the concentration is the more important factor for controlling the chemical reactions rate. Here physically altering the concentrations by an excitation of an external electric field excitation acting on an ion-release (short lifetime) and free-radical-release (long lifetime) devices is the most effective way which do not change the chemical species in chemical ways.

Referred to [5, Chapter 3], [16, Chapter 2], [23], [2], [15, Chapter 20], [13], [18], which give us the free radical meaning that is a chemically stable or transient paramagnetic atomic or molecular species which derives its paramagnetism from a single, unpaired valence shell electron and how to produce them by physical and chemical ways. Radicals attack double bonds and cause to the fast chemical reaction occurrence, but unlike similar ions, they are not as much directed by electrostatic interactions.

Referred to [11], [17], [20], corona and glow discharges which providing high strength of electric field with frequencymodulated operation are revealed and then the highest concentration of ions or free radicals obtained. In (4), if increasing the strength and frequency of the electric field and having good electrical conductivity like as field-emission materials, referred to [9], [15, Chapter 20], [25], [1], [26], [10], which could be choice of carbon nanotube (CNT), fullerene (C₆₀) and its derivatives, for example, C₆₀(OH)ₙ, graphene membranes and boron-doped diamond thin films providing the best conductivity to produce the highest concentrations of ions or free radicals (for example, over 10¹² number/cm³, referred to [14, Chapter 1]). For controlling the conductivity of electrolyte solutions [3, page 124], having the higher electric field strength (E>10⁶ to 10⁷ Volt/m) and high operating frequency over 1.0 MHz is the most straightforward way.

### REFERENCES

[1] A. ABE, K. D USEK, S. KOBAYASHI, T. FUHRMANN-LIEKER, A. GRIMS-DALE, J. JANG, M. KANEKO, K. MÃIJLLEN, R. PUDZICH, J. SAL-BECK, AND M. YAGI. “Emissive Materials—Nanomaterials”. Springer, http://www.springer.de (2006).
[2] W. ADAM, J. HOWARD, F. NEUGEBAUER, C. VAN BARNEVELD, O. EMMERT, AND W. MAAS. “Magnetic Properties of Free Radicals”. Springer, http://www.springer.de (2008).
[3] V. S. BAGOTSKY. “Fundamentals of electrochemistry”. John Wiley and Sons, Inc., http://www.wiley.com, 2nd ed. (2005).
[4] V. BALZANI, P. PIOTROWIAK, M. A. J. RODGERS, J. MATTAY, D. AsTRUC, H. B. GRAY, J. WINKLER, S. FUKUZUMI, T. E. MALLOUK, Y. HAAS, A. P. DE SILVA, I. GOULD, AND R. A. MARCUS. “Electron Transfer in Chemistry”, vol. 5-Vol. John Wiley and Sons, Inc., http://www.wiley.com, 1st ed. (2001).
[5] A. J. BARD AND L. R. FAULKNER. “Electrochemical Methods: Fundamentals and Applications”. John Wiley and Sons, Inc., http://www.wiley.com, 2nd ed. (2000).
[6] B. J. BERNE AND R. PECORA. “Dynamic Light Scattering: With Applications to Chemistry, Biology, and Physics”. Dover Publications, http://www.dover.com, 1st ed. (2000).
[7] K. S. BIRDI. “Introduction to Electrical Interfacial Phenomena”. CRC Press, http://www.crcpress.com/ (2010).
[8] C. M. A. BRETT AND A. M. O. BRETT. “Electrochemistry: Principles, Methods, and Applications”. Oxford University Press, http://ukcatalogue.oup.com/, 2nd ed. (1993).
[9] T. BURCHELL. “Carbon Materials for Advanced Technologies”. Elsevier Science, http://www.elsevier.com (1999).
[10] A. CHAUDHRY AND H. KLEINPOPPEN. “Analysis of Excitation and Ionization of Atoms and Molecules by Electron Impact”. Springer, http://www.springer. de (2010).
[11] J. CHEN. “DIRECT CURRENT CORONA-ENHANCED CHEMICAL REACTIONS”. PhD thesis, UNIVERSITY OF MINNESOTA (August 2002).
[12] W. T. COFFEY, Y. P. KALMYKOV, AND J. T. WALDRON. “The Langevin Equation: With Applications to Stochastic Problems in Physics, Chemistry and Electrical Engineering”, vol. 14. World Scientific Pub Co. Inc., http://www.worldscientific.com/, 2nd ed. (2004).
[13] C. D. FORBES. “Carbon-Centered Free Radicals and Radical Cations: Structure, Reactivity, and Dynamics”. John Wiley and Sons, Inc., http://www.wiley.com (2010).
[14] A. FRIDMAN. “Plasma Chemistry”. Cambridge University Press, http://www.cambridge.org (2008).
[15] A. FUJISHIMA, Y. EINAGA, T. N. RAO, AND D. A. TRYK. “Diamond Electrochemistry”. Elsevier Science, http://www.elsevier.com (2005).
[16] P. L. HOUSTON. “Chemical Kinetics and Reaction Dynamics”. Dover Publications, http://store.doverpublications.com (2006).
[17] R. G. JAHN. “Physics of Electric Propulsion”. Dover Publications, http://www.dover.com/ (2006).
[18] K. M. KADISH AND R. S. RUOFF. “Fullerenes: Chemistry, Physics, and Technology”. John Wiley and Sons, Inc., http://www.wiley.com (2000).
[19] D. KONDEPUDI AND I. PRIGOGINE. “Modern Thermodynamics: From Heat Engines to Dissipative Structures”. John Wiley and Sons, Inc., http://www.wiley.com (1998).
[20] R. K. MARCUS AND J. A. C. BROEKAERT. “Glow Discharge Plasmas in Analytical Spectroscopy”. John Wiley and Sons, Inc., http://www.wiley.com (2003).
[21] E. W. MAX BORN. “Principles of Optics”. Cambridge Press, 7th ed. (1999).
[22] H. OHSHIMA. “Theory of Colloid and Interfacial Electric Phenomena”, vol. 12. Academic Press, http://www.elsevier.com (2006).
[23] T. V. PERCHYONOK. “Radical Reactions in Aqueous Media”. Royal Society of Chemistry, http://www.rsc.org/Shop/Books/ (2009).
[24] V. POLSHETTIWAR AND R. S. VARMA. “Aqueous Microwave Assisted Chemistry: Synthesis and Catalysis”. Royal Society of Chemistry, http://www.rsc.org/Shop/Books/ (2010).
[25] J. RASO-PUEYO AND V. HEINZ. “Pulsed Electric Fields Technology for the Food Industry: Fundamentals and Applications”. Springer, http://www.springer.de (2006).
[26] Y. SAITO. “Carbon Nanotube and Related Field Emitters: Fundamentals and Applications”. John Wiley and Sons, Inc., http://www.wiley.com (2010).
[27] H. G. TOMPKINS AND W. A. MCGAHAN. “Spectroscopic Ellipsometry and Reflectometry: A User's Guide”. John Wiles and Sons, Inc (1999).

### DETAILED DESCRIPTION OF THE INVENTION

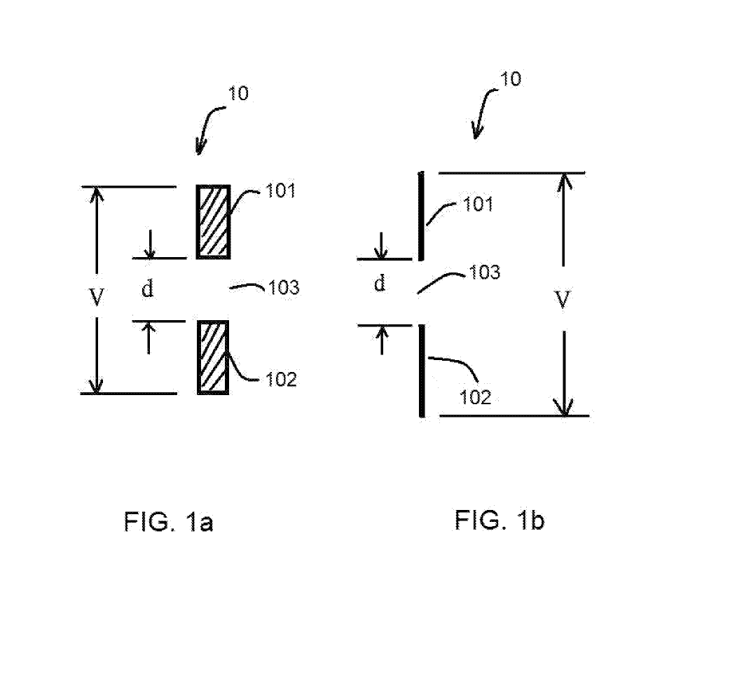

Before going further, an open circuit device is introduced first. FIG. 1a has shown an open circuit device 10 comprising a first terminal 101 and a second terminal 102 separating the first terminal 101 by an open gap 103 having an open gap width d. The open circuit device 10 is driven by a voltage v. By properly adjusting the voltage v across the open gap 103, the frequency of the voltage v, and the open gap width d, an electrical discharge between the first terminal 101 and the second terminal 102 of the open circuit device 10 can take place and at least one of the first terminal 101 and the second terminal 102 is a discharge electrode of the electrical discharge. The type of the electrical discharge is not limited, for example, the electrical discharge can be corona discharge or glow discharge. The shapes of the first terminal 101 and the second terminal 102 are not limited, for example, the shape can be in needle as shown in FIG. 1b or a surface as shown in FIG. 1a. A surface can be viewed as formed by a plurality of needles (or called “micro needle array”). The first terminal 101 and the second terminal 102 are not limited, for example, they can be conductors or semiconductors.

If a high electrical field drives an open circuit device, then a high electrical field can be built at the open circuit device. If a charge-release device is disposed by the open circuit device under the influence of the high electrical field built at the open circuit device, then charges can be released from the charge-release device by the excitation of the high electrical field. A high electrical field with single polarity exciting a charge-release device can only produce positive charges or negative charges depending on the polarity, for example, an electrical field with positive polarity acting on a charge-release device will produce positive charges and an electrical field with negative polarity acting on a charge-release device will produce negative charges.

A high electrical field with both opposite polarities acting on a charge-release device can produce positive charges and negative charges, which can very possibly neutralize together. A driver which can produce high electrical field output at an adjustable bandwidth is called high electrical field driver with frequency-modulation capability or frequency-modulated high electrical field driver in the present invention.

Coefficients of oxidation reaction and reduction reaction as k_{Ox}, k_{red}, C_{Ox}, and C_{red} are always correlated. Shown in (18), the net exchange current are related to some factors as the electrodes area A, chemical reaction rate constants as k_{red} (at reduction), k_{Ox}, (at oxidation), bulk concentrations C_{red} (at reduction), c_{Ox}, (at oxidation), and electrode polarization or overpotential ΔE. Furthermore, the chemical reaction rate is proportional to the total exchange currents on the electrodes as well as the polarizations on the electrodes. Shown in (18), the ion concentration is the more important factor for controlling the chemical reactions rate.

A polarization of an electrode is defined by a shift of potential away from an equilibrium value of the electrode. A higher polarization (a higher potential shift) on an electrode,

$$Δ E > \frac{RT}{F} ,$$

expresses a lower conductivity of electrodes which is hard to discharge spontaneously, that is the slower reaction rate of electrodes obtained. For a lower polarization (a lower potential shift),

$$Δ E < \frac{RT}{F} ,$$

expresses a higher conductivity of electrodes and a fast reaction rate of electrodes is obtained. This explains the reason why an external electric field can't be applied to electrodes and it has to be applied to electrolyte solution not to electrodes. According to the analysis above, the electrical field was introduced but nothing talked about current. Current can only be observed in a closed loop so that the electrical field has to be implemented by an open circuit. A frequency-modulated high electrical field driver driving an open circuit device can produce high electrical field at the open circuit device at a frequency.

The goal is that by providing external energy interacts with an electrolyte solution of an electricalchemical device to change the activation energy at the electrodes to cause the chemical reactions to happen at the electrodes resulting in obtaining current flowing between two electrodes of the electricalchemical device. A frequency-modulated high electrical field driver can produce a high electrical field output with single polarity at a frequency to drive an open circuit device where a high electrical field presents. A charge-release device electrically connects to the electrolyte solution of the electricalchemical device and the charge-release device can be disposed by the open circuit device under the influence of its high electrical field to produce positive charges or negative charges depending on the polarity of the high electrical field output produced by the frequency-modulated high electrical field driver. If the charge-release device is a high current density device, then a very high density positive charges or negative charges will be transferred into the electrolyte solution. At equilibrium, the electrolyte solution of the electricalchemical device is electrically neutralized, in other words, there is no free electron in the electrolyte solution. The released high density charges in the electrolyte solution will diffuse outward and ride on the particles in the electrolyte solution to change the ion concentration in the electrolyte solution. Those charges migrate to an electrode to change an activation energy or potential of the electrode and once the activation energy or potential at the electrode over its activation energy bandgap a chemical reaction takes place at the electrode to produce current as shown by equation (18).

A high concentration of charged particles excited by an electrical field with a high electric field strength and a high operating frequency to drive the electrical field are critical. For example, a high concentration of charged particles over 10¹² number/cm³ referred to [14, Chapter 1]), a high electric field strength up to E>10⁶ to 10⁷ Volt/m and a high operating frequency over 1.0 MHz to control the conductivity of an electrolyte solution [3, page 124] has shown a good result.

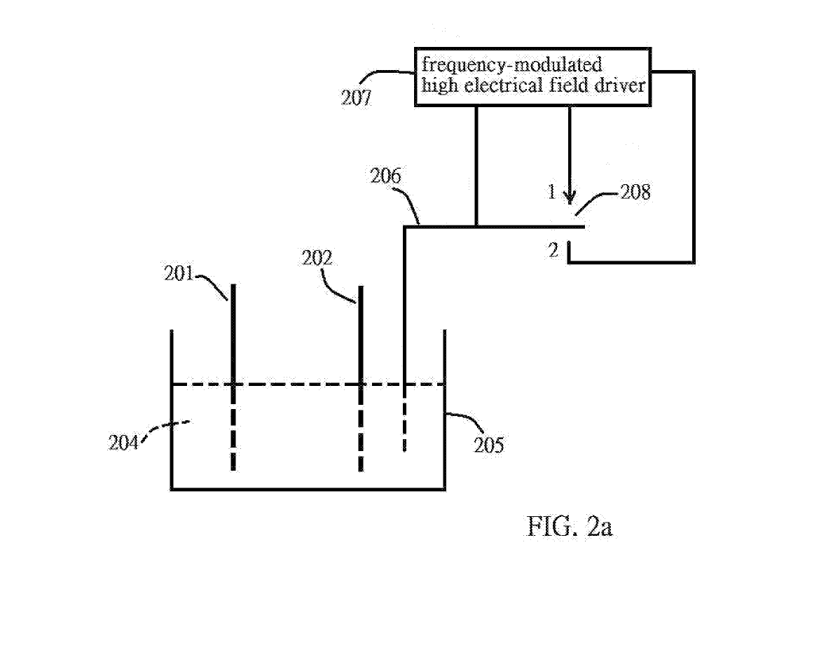

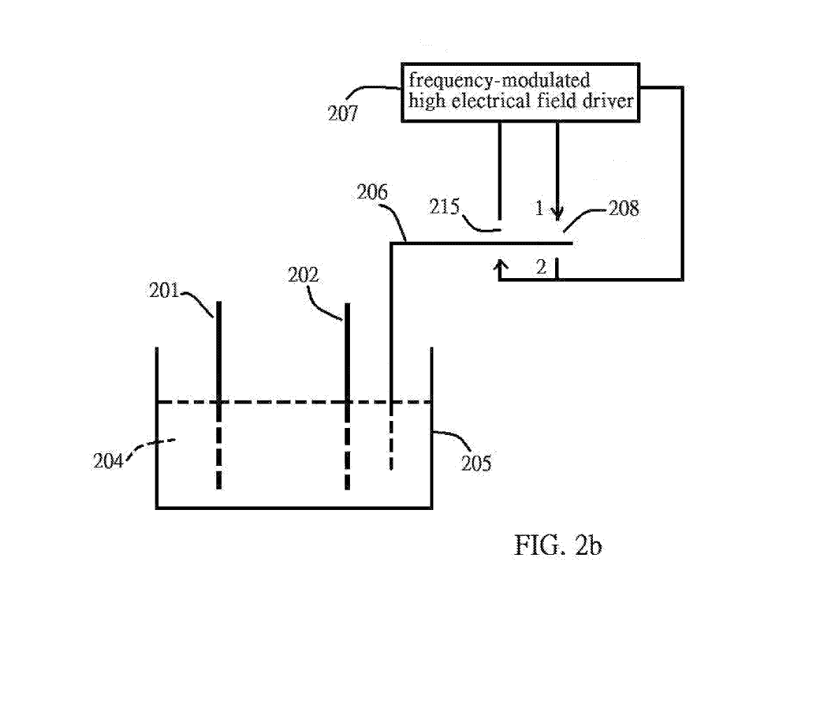

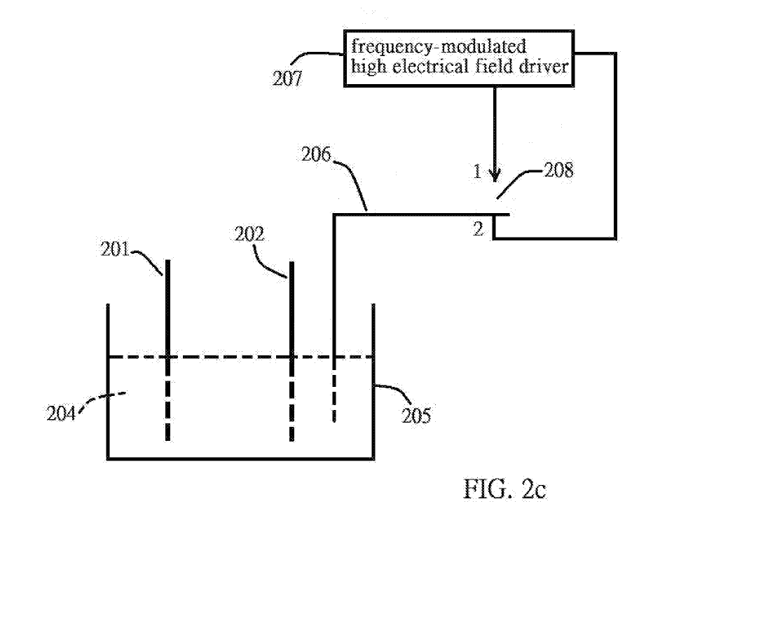

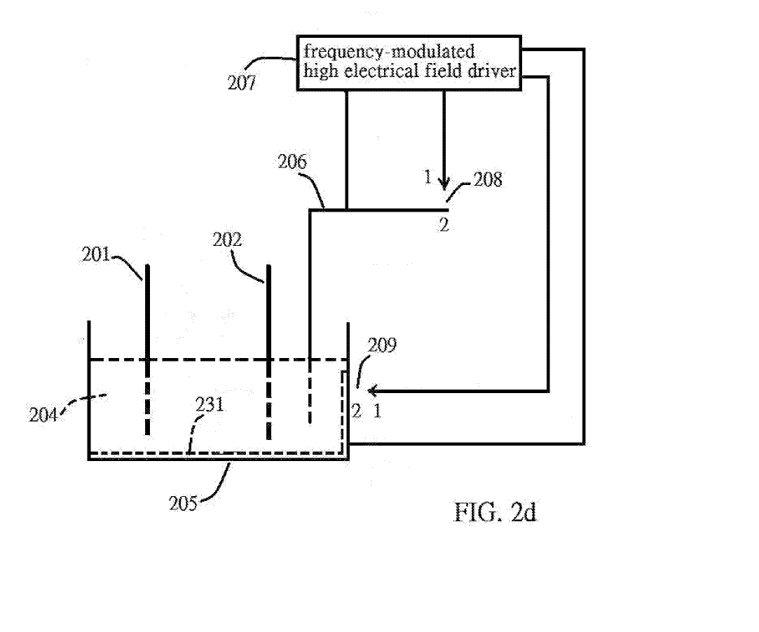

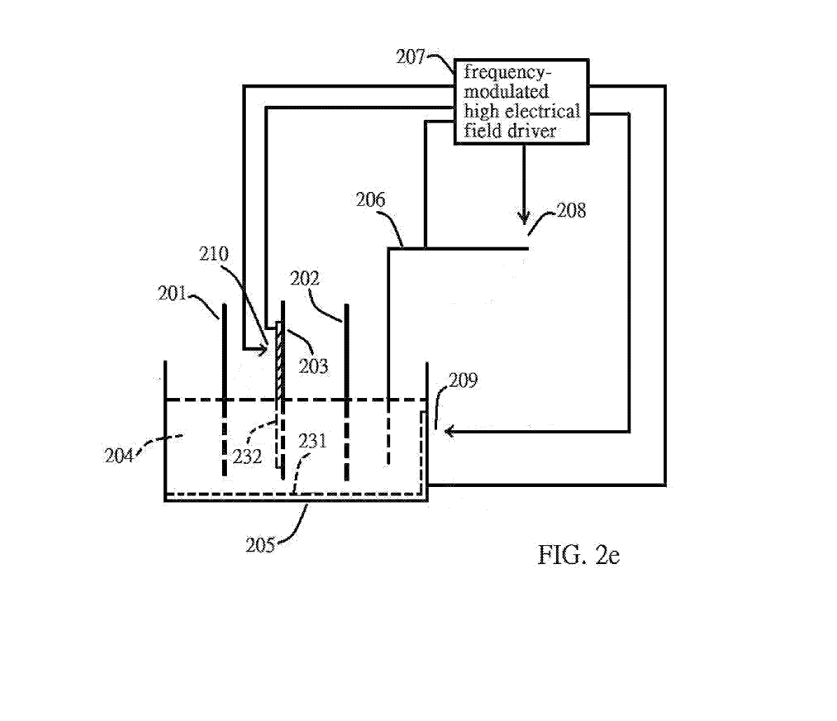

Some embodiments are presented as following according to the information of the background information and the discussion above. FIG. 2a has shown an electricalchemical device in front view comprising a first electrode 201, a second electrode 202 and an electrolyte solution 204 electrically connecting to the first electrode 201 and the second electrode 202. FIG. 2a has also shown a frequency-modulated high electrical field driver 207 for producing a high electrical field output with single polarity to drive a first open circuit device 208 at a frequency where a high electrical field presents. FIG. 2a has also shown a first charge-release device 206 electrically connected to the electrolyte solution 204 and disposed by the first open circuit device 208 under the influence of the high electrical field built at the first open circuit device 208 to release positive charges or negative charges into the electrolyte solution 204. The discharged high density charges will diffuse outward and carry on the particles in the electrolyte solution to change the ion concentration in the electrolyte solution. Electrons will be adsorbed to an electrode to change an activation energy or potential of the electrode, and once the activation energy or potential at the electrode over its activation energy bandgap, a chemical reaction takes place at the electrodes.

The first charge-release device 206 should be a very good conductivity material and a high current density material. It's advantageous for an electricalchemical device if the first charge-release device 206 doesn't chemically react and corrode with the electrolyte solution 204. It's also advantageous for the first charge-release device 206 having small cross-section area such that charges are easier to escape from a small area. The first chargerelease device 206 is not limited, for example, it can be carbon nano-tube (CNT), fullerene (C₆₀) and its derivatives such as C₆₀(OH)ₙ, graphene membranes, or boron-doped diamond thin films, etc. CNT is a very good conductivity material and a high current density material containing numerous very tiny surfaces which are harder to hold electrons if it is under a high electrical field.

The first open circuit device 208 has advantaged high electrical field and low current because it's not a closed loop resulting in low power consumed. The first charge-release device 206 can also be disposed to electrically connect to any one of the two terminal of the first open circuit device 208. For example, as shown in FIG. 2c which has shown the first charge-release device 206 disposed to electrically connect to a second terminal, marked by 2, of the first open circuit device 208.

The frequency-modulated high electrical field driver 207 is not limited, for example, the frequency-modulated high electrical field driver 207 can be our previous invention titled “a high electrical field driver” by U.S. patent application Ser. No. 13/229,726.

The electrolyte 204 can be acid electrolyte solution, base electrolyte solution, or alkaline electrolyte solution. The first electrode 201 can be an oxidation electrode or a reduction electrode and the second electrode 202 can be a reference electrode, which describes a primary battery, or the first electrode 201 can be an oxidation electrode and the second electrode 202 can be a reduction electrode, which describes a secondary battery. The oxidation electrode is defined as an electrode having oxidation reaction and the reduction electrode is defined as an electrode having reduction reaction. The type of the electrode and the type of the electrolyte solution decide the polarity of the charges to transfer into the electrolyte solution to accelerate the chemical reaction to enlarge current output.

For example, if a primary battery has an oxidation electrode and an alkaline electrolyte solution, then negative charges are transferred into the electrolyte solution to activate an oxidation reaction at the oxidation electrode to enlarge current output. The oxidation electrode after the oxidation reaction can be reversed by applying positive charges into the electrolyte solution of the primary battery so that the primary battery can be a rechargeable battery by the ionization process. FIG. 2b has shown a first open circuit 208 and a second open circuit device 215 of which one provides negative charges for activating the oxidation reaction and the other one provides negative charges for proceeding reduction reaction at the oxidation electrode.

If a primary battery has an oxidation electrode and an acid electrolyte solution, then positive charges are transferred into the electrolyte solution to activate an oxidation reaction at the oxidation electrode to enlarge current output. The oxidation electrode after the oxidation reaction can be reversed by applying negative charges into the electrolyte solution of the primary battery so that the primary battery can be a rechargeable battery by the ionization process.

If a primary battery has an reduction electrode and an alkaline electrolyte solution, then positive charges are transferred into the electrolyte solution to activate a reduction reaction at the reduction electrode to enlarge current output. The reduction electrode after the reduction reaction can be reversed by applying negative charges into the electrolyte solution of the primary battery so that the primary battery can be a rechargeable battery by the ionization process.

If a primary battery has an reduction electrode and an acid electrolyte solution, then negative charges are transferred into the electrolyte solution to activate a reduction reaction at the reduction electrode to enlarge current output. The reduction electrode after the reduction reaction can be reversed by applying positive charges into the electrolyte solution of the primary battery so that the primary battery can be a rechargeable battery by the ionization process.

If a primary battery has an oxidation electrode and a base electrolyte solution, then negative charges are transferred into the base electrolyte solution to activate an oxidation reaction at the oxidation electrode to enlarge current output except hydrogen electrode which needs positive charges to activate an oxidation reaction at the oxidation electrode. The oxidation electrode after the oxidation reaction can be reversed by applying positive charges into the electrolyte solution of the primary battery so that the primary battery can be a rechargeable battery by the ionization process.

If a primary battery has an reduction electrode and a base electrolyte solution, then positive charges are transferred into the base electrolyte solution to activate a reduction reaction at the reduction electrode to enlarge current output. The reduction electrode after the reduction reaction can be reversed by applying negative charges into the electrolyte solution of the primary battery so that the primary battery can be a rechargeable battery by the ionization process.

For a secondary battery, positive charges or negative charges can be transferred into the electrolyte solution to activate a reduction reaction at the reduction electrode or to activate an oxidation reaction at the oxidation electrode to accelerate the chemical reaction to enlarge current output, and, both the oxidation reaction and the reduction reaction proceed in the secondary battery at the same time.

A charge-release device can be attached to the container containing the electrolyte solution of the electrical-chemical device and the charge-release device is electrically connected with the electrolyte solution as shown by FIG. 2d. FIG. 2d has shown a second charge-release device 231 attaching to an inner wall of a container 205 and electrically connected with the electrolyte solution 204 and disposed by a third open circuit device 209.

A charge-release device can be attached to a separator and the charge-release device is electrically connected with the electrolyte solution as shown by FIG. 2e. FIG. 2e has shown a third charge-release device 232 attaching a separator 203 and electrically connected with the electrolyte solution 204 and disposed by a fourth open circuit device 210.

### SUMMARY OF THE INVENTION

By providing external energy interacts with an elec-trolyte solution of an electricalchemical device to change the activation energy at the electrodes to accelerate the rate of chemical reactions resulting in enlarging current output, and an electrokinetics process to control an electricalchemical device has been invented.

### BRIEF DESCRIPTION OF THE DRAWINS

FIG. 1a has shown an embodiment of an open circuit device;

FIG. 1b has shown an embodiment of an open circuit device;

FIG. 2a has shown an embodiment of an electrical-chemical device;

FIG. 2b has shown an embodiment of an electrical-chemical device;

FIG. 2c has shown an embodiment of an electrical-chemical device;

FIG. 2d has shown an embodiment of an electrical-chemical device; and

FIG. 2e has shown an embodiment of an electrical-chemical device.

1. An electricalchemical device, comprising:
a first electrode;
a second electrode;
an electrolyte solution electrically connecting with the first electrode and the second electrode;
a first open circuit device having a first terminal and a second terminal;
a high electrical field driver for producing a high electrical field output with single polarity at an adjustable bandwidth; and
a first charge-release device for releasing charges under an electrical field;
wherein the high electrical field driver produces at least a high electrical field output, and a first high electrical field output produced by the high electrical field driver drives the first open circuit device such that a high electrical field is formed at the first open circuit device, and the first charge-release device is disposed by the first open circuit device under an influence of the high electrical field built at the first open circuit device to release positive charges or negative charges depending on the polarity of the first high electrical field output produced by the high electrical field driver, and the first charge-release device is electrically connected to the electrolyte solution such that the positive charges or the negative charges released from the first charge-release device activate one of the first electrode and the second electrode to accelerate the chemical reaction to enlarge a current output, and the current output is controllable by the adjustable bandwidth of the high electrical field output produced by the high electrical field driver.

2. The electricalchemical device of claim 1, wherein the first electrode is an oxidation electrode and the second electrode is a reference electrode.

3. The electricalchemical device of claim 1, wherein the first electrode is a reduction electrode and the second electrode is a reference electrode.

4. The electricalchemical device of claim 1, wherein the first electrode is an oxidation electrode and the second electrode is a reference electrode.

5. The electricalchemical device of claim 2, wherein the electrolyte solution is an alkaline electrolyte solution, and negative charges are transferred into the electrolyte solution to activate an oxidation reaction at the oxidation electrode to enlarge current output, and the oxidation electrode after the oxidation reaction is reversed by applying positive charges into the electrolyte solution such that the electricalchemical device is a rechargeable battery by the ionization process.

6. The electricalchemical device of claim 2, wherein the electrolyte solution is an acid electrolyte solution, and positive charges are transferred into the electrolyte solution to activate an oxidation reaction at the oxidation electrode to enlarge current output, and the oxidation electrode after the oxidation reaction is reversed by applying negative charges into the electrolyte solution such that the electricalchemical device is a rechargeable battery by the ionization process.

7. The electricalchemical device of claim 3, wherein the electrolyte solution is an alkaline electrolyte solution, and positive charges are transferred into the electrolyte solution to activate a reduction reaction at the reduction electrode to enlarge current output, and the reduction electrode after the reduction reaction is reversed by applying negative charges into the electrolyte solution such that the electricalchemical device is a rechargeable battery by the ionization process.

8. The electricalchemical device of claim 3, wherein the electrolyte solution is an acid electrolyte solution, and negative charges are transferred into the electrolyte solution to activate an reduction reaction at the reduction electrode to enlarge current output, and the reduction electrode after the reduction reaction is reversed by applying positive charges into the electrolyte solution such that the electricalchemical device is a rechargeable battery by the ionization process.

9. The electricalchemical device of claim 3, wherein the electrolyte solution is a base electrolyte solution, and negative charges are transferred into the base electrolyte solution to activate an oxidation reaction at the oxidation electrode to enlarge current output except hydrogen electrode which needs positive charges to activate an oxidation reaction at the oxidation electrode, and the oxidation electrode after the oxidation reaction can be reversed by applying positive charges into the electrolyte solution such that the electricalchemical device is a rechargeable battery by the ionization process.

10. The electricalchemical device of claim 3, wherein the electrolyte solution is a base electrolyte solution, then positive charges are transferred into the base electrolyte solution to activate a reduction reaction at the reduction electrode to enlarge current output, and the reduction electrode after the reduction reaction can be reversed by applying negative charges into the electrolyte solution such that the electricalchemical device is a rechargeable battery by the ionization process.

11. The electricalchemical device of claim 4, wherein the first high electrical field output with either the positive polarity or the negative polarity driven by the high electrical field driver excites the first charge-release device to release positive charges or negative charges into the electrolyte to accelerate the chemical reactions to enlarge a current output.

12. The electricalchemical device of claim 4, wherein the electrolyte is an alkaline electrolyte solution, negative charges released by the first charge-release device produce oxidation reaction at the oxidation electrode to accelerate the chemical reactions to enlarge a current output.

13. The electricalchemical device of claim 4, wherein the electrolyte is an acid electrolyte solution, positive charges released by the first charge-release device produce oxidation reaction at the oxidation electrode to accelerate the chemical reactions to enlarge a current out-put.

14. The electricalchemical device of claim 1, further comprising a container containing the electrolyte solution, a second charge-release device for releasing charges under an electrical field, and a second open circuit device driven by a second high electrical field output produced by the high electrical field driver, wherein the second charge-release device attaches to the inner wall of the container and electrically connects to the electrolyte solution, and the second charge-release device is disposed by the second open circuit device under an influence of a high electrical field built at the second open circuit device to release charges into the electrolyte solution.

15. The electricalchemical device of claim 1, further comprising a separator separating the first electrode and the second electrode, a third charge-release device for releasing charges under an electrical field, and a third open circuit device driven by a third high electrical field out-put produced by the high electrical field driver, wherein the third charge-release device attaches to the separator and electrically connects to the electrolyte solution, and the third charge-release device is disposed by the third open circuit device under an influence of a high electrical field built at the third open circuit device to release charges into the electrolyte solution.

16. The electricalchemical device of claim 2, further comprising a separator separating the first electrode and the second electrode, a third charge-release device for releasing charges under an electrical field, and a third open circuit device driven by a third high electrical field out-put produced by the high electrical field driver, wherein the third charge-release device attaches to the separator and electrically connects to the electrolyte solution, and the third charge-release device is disposed by the third open circuit device under an influence of a high electrical field built at the third open circuit device to release charges into the electrolyte solution.

17. The electricalchemical device of claim 1, further comprising a container containing the electrolyte solution, wherein the first charge-release device attaches to the inside wall of the container and electrically connects with the electrolyte solution.

18. The electricalchemical device of claim 1, further comprising a separator separating the first electrode and the second electrode, wherein the first charge-release device attaches to the separator and electrically connects with the electrolyte solution.

19. The electricalchemical device of claim 1, wherein the first charge-release device is carbon nano-tube (CNT), fullerene (C₆₀) and its derivatives as C₆₀(OH)ₙ, graphene membranes, or boron-doped diamond thin films.

20. The electricalchemical device of claim 14, wherein the second charge-release device is carbon nano-tube (CNT), fullerene (C₆₀) and its derivatives as C₆₀(OH)ₙ, graphene membranes, or boron-doped diamond thin films.

21. The electricalchemical device of claim 15, wherein the third charge-release device is carbon nano-tube (CNT), fullerene (C₆₀) and its derivatives as C₆₀(OH)ₙ, graphene membranes, or boron-doped diamond thin films.

22. The electricalchemical device of claim 16, wherein the third charge-release device is carbon nano-tube (CNT), fullerene (C₆₀) and its derivatives as C₆₀(OH)ₙ, graphene membranes, or boron-doped diamond thin films.
